(19) United States
(12) Patent Application Publication
(10) Pub. No.: US 2006/0127601 A1
(43) Pub. Date: Jun. 15, 2006

(54) Film formation method

(75) Inventors: Seishi Murakami, Nirasaki-shi (JP); Masato Morishima, Nirasaki-shi (JP); Kensaku Narushima, Nirasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOKYO ELECTRON LIMITED, Minato-ku (JP)

(21) Appl. No.: 11/350,799

(22) Filed: Feb. 10, 2006

Related U.S. Application Data
(63) Continuation-in-part of application No. PCT/JP04/07554, filed on May 26, 2004.

(30) Foreign Application Priority Data
Aug. 11, 2003 (JP) 2003-291667

(51) Int. Cl. H05H 1/24

(52) U.S. Cl. 427/569

(57) ABSTRACT

A titanium silicide film is formed on an Si wafer. At first, a plasma process using an RF is performed on the Si wafer. Then, a Ti-containing source gas is supplied onto the Si wafer processed by the plasma process and plasma is generated to form a Ti film. At this time, the Ti silicide film is formed by a reaction of the Ti film with Si of the Si wafer. The plasma process is performed on the Si wafer while the Si wafer is supplied with a DC bias voltage having an absolute value of 200V or more.

### CROSS-REFERENCE TO RELATED APPLICATIONS

This is a Continuation-in-Part Application of PCT Application No. PCT/JP2004/007554, filed May 26, 2004, which was published under PCT Article 21(2) in Japanese.

This application is based upon and claims the benefit of priority from prior Japanese Patent Application No. 2003-291667, filed Aug. 11, 2003, the entire contents of which are incorporated herein by reference.

### BACKGROUND OF THE INVENTION

1. Field of the Invention

The present invention relates to a film formation method for performing a plasma process on a target object, such as an Si-containing portion, e.g., an Si-substrate surface or metal silicide layer to form a metal silicide film.

2. Description of the Related Art

In recent years, multi-layered interconnection structures are being increasingly used for circuitry, because higher density and higher integration degree are required in manufacturing semiconductor devices. Under the circumstances, embedding techniques for electrical connection between layers have become important, e.g., at contact holes used as a connection between an underlying semiconductor device and upper interconnection layers, and at via-holes used as a connection between upper and lower interconnection layers.

In general, Al (aluminum), W (tungsten), or an alloy made mainly of these materials is used as the material for filling such contact holes and via-holes. In this case, it is necessary to form good contact between the metal or alloy and an underlying layer, such as an Si substrate or poly-Si layer. For this reason, before forming the filler, a Ti film is formed on the inner surface of the contact holes or via-holes, and a TiN film is further formed thereon as a barrier layer.

In order to form Ti films or TiN films of this kind, chemical vapor deposition (CVD) is utilized, because this method can suppress increase in the electric resistance, provide the films with better quality, and attain high step coverage, even where devices are miniaturized and highly integrated. Where a Ti film is formed by CVD using TiCl₄ as a source material, the formed film reacts with underlying Si. Consequently, TiSi₂ is selectively grown in self-alignment on Si diffusion layers at the bottom of contact holes, thereby attaining an improved ohmic resistance (for example, Patent document 1 mentioned later).

In general, where a CVD-Ti film is formed, TiCl₄ gas is used as a source gas, as described above, and H₂ gas or the like is used as a reducing gas. TiCl₄ gas has a relatively high binding energy, and does not decompose unless the process temperature is as high as about 1,200° C., when thermal energy is solely used. Accordingly, in general, where TiCl₄ gas is used, the film formation is performed by plasma CVD utilizing plasma energy as well as a process temperature of about 650° C.

On the other hand, where a metal film of this kind is formed, a process for removing natural oxide films on an underlayer is performed prior to film formation so as to improve the contact resistance. In general, such natural oxide films are removed by dilute hydrogen fluoride. Further, there is an apparatus using hydrogen gas and argon gas to remove natural oxide films, as proposed in Patent document 2 mentioned later.

However, as devices are more miniaturized, the depth of, e.g., Si diffusion layers is smaller, which makes it difficult for a TiSi₂ film formed by conventional Ti-CVD methods to satisfy a required contact resistance.

In order to decrease the contact resistance, it is effective to mainly form TiSi₂ of the C54 crystal structure, which has a lower resistivity, thereby decreasing the resistivity of a TiSi₂ film itself. In this case, conventional Ti-CVD methods require the use of a high process temperature, which makes it difficult to form a TiSi₂ film consisting mainly of TiSi₂ of the C54 crystal structure.

Further, as described above, where conventional plasma CVD methods are used to form a Ti film, TiSi₂ crystals less uniform in grain size tend to be formed. Particularly, where natural oxide films are removed by argon plasma prior to formation of a TiSi₂ film, the surface of Si diffusion layers is damaged and less uniformly becomes amorphous. If a Ti film is formed by plasma CVD in this state, the TiSi₂ crystals formed become less uniform. Where such less uniform TiSi₂ crystals are present in a relatively low density, the contact between the TiSi₂ film and underlayer brings about a high resistivity and low uniformity. Consequently, the contact resistance is increased.

On the other hand, as described above, as devices are more miniaturized and the depth of Si diffusion layers is smaller, a TiSi₂ film formed at the bottom of contact hole is thinner, which requires better morphology at the interface between the Si diffusion layers and TiSi₂ film. However, according to conventional Ti-CVD methods, the grain size of TiSi₂ crystals is large and less uniform, which makes it difficult to attain sufficient interface morphology.

[Patent document 1] Jpn. Pat. Appln. KOKAI Publication No. 5-67585 (see claim 1, FIG. 1, and the explanation thereof).

[Patent document 2] Jpn. Pat. Appln. KOKAI Publication No. 4-336426 (FIG. 2 and the explanation thereof).

### BRIEF SUMMARY OF THE INVENTION

The present invention has been made in consideration of the problems described above, and has an object to provide a film formation method for forming a metal silicide film, such as a titanium silicide film, having a resistivity lower than that obtained by the conventional technique, without increasing the film formation temperature, where the metal silicide film is formed on an Si-containing portion of an target object. Another object of the present invention is to provide a film formation method for forming a metal silicide film, particularly a titanium silicide film, with a uniform crystal grain size. Another object of the present invention is to provide a film formation method for forming a metal silicide film, particularly a titanium silicide film, which consists of fine and uniform crystal grains and thus provides good interface morphology.

In order to attain one of the objects described above, according to a first aspect of the present invention, there is provided a film formation method for forming a metal silicide film on an Si-containing portion of a target object, the method comprising: performing a plasma process using an RF on the Si-containing portion; and supplying a metal-containing source gas, which contains a metal of the metal silicide film to be formed, onto the Si-containing portion processed by the plasma process and generating plasma to form a metal film containing the metal, thereby forming the metal silicide film by a reaction of the metal film with Si of the Si-containing portion, wherein the plasma process is performed on the Si-containing portion while the target object is supplied with a DC bias voltage (Vdc) having an absolute value of 200V or more

As described above, when the plasma process using an RF is performed on the Si-containing layer prior to the film formation, the target object is supplied with a DC bias voltage (Vdc) having an absolute value of 200V or more. In this case, ions in plasma act on the surface of the target object more intensively than in conventional natural oxide film removal. Due to the presence of such ions, the underlying Si-containing layer for the film formation is made amorphous overall and a highly reactive state is formed (in the case of Si, a surface state is formed such that more Si dangling bonds are present than in mono-crystalline Si). Consequently, a larger number of metal silicide crystals having a crystal structure, which provides a lower resistivity, such as titanium silicide of the C54 crystal structure, can be formed by a lower temperature than in the conventional technique. It follows that a metal silicide film with a smaller thickness and a lower resistivity than those obtained by the conventional technique can be formed without increasing the film formation temperature, thereby lowering the contact resistance. Further, even where the film formation is performed at a target object temperature lower than in the conventional technique, a metal silicide film can be formed with crystallinity of the same level as in the conventional technique.

In the first aspect, the Si-containing portion may comprise an Si-substrate, poly-Si, or metal silicide, and a typical example thereof is a contact diffusion layer formed in a mono-crystalline Si-substrate (Si wafer). This Si-substrate includes one doped with B, P, or As. The plasma process may be performed on the Si-containing portion, using inductively coupled plasma. Alternatively, the plasma process may be performed, using parallel plate type plasma or microwave plasma. Further, the metal silicide film may be formed by repeating, a plurality of times, supply of the metal-containing source gas, and reduction of the metal-containing source gas by plasma generation and supply of a reducing gas. In this case, the film formation can be performed at a lower temperature. Examples of the metal are Ni, Co, Pt, Mo, Ta, Hf, and Zr, in addition to Ti described above. In general, these metals can form a metal silicide crystal structure at a high temperature with a low resistivity.

According to a second aspect of the present invention, there is provided a film formation method for forming a metal silicide film on an Si-containing portion of a target object, the method comprising: removing a natural oxide film on the Si-containing portion; and forming the metal silicide film on the Si-containing portion of the target object after the natural oxide film is removed, wherein the metal silicide film is formed by first supplying a metal-containing source gas, which contains a metal of the metal silicide film to be formed, without plasma generation for a predetermined time to produce metal-silicon bonds, and then supplying the metal-containing source gas and generating plasma to form a metal film containing the metal, thereby forming the metal silicide film by a reaction of the metal film with the Si-containing portion.

According to a third aspect of the present invention, there is provided a film formation method for forming a titanium silicide film on an Si-containing portion of a target object, the method comprising: removing a natural oxide film on the Si-containing portion; and forming the titanium silicide film on the Si-containing portion of the target object after the natural oxide film is removed, wherein the titanium silicide film is formed by first supplying a Ti-containing source gas without plasma generation for a predetermined time to produce Ti—Si bonds, and then supplying the Ti-containing source gas and generating plasma to form a Ti film, thereby forming the titanium silicide film by a reaction of the Ti film with the Si-containing portion.

According to studies made by the present inventors, it has been found that, conventionally, TiSi₂ crystals are formed with less uniform grain size, because supply of a Ti-containing source gas and plasma generation are simultaneously performed, so plasma is generated before a sufficient amount of the Ti-containing source gas is supplied onto the target object surface. In this case, TiSi₂ starts crystal growth in a state where the number of Ti—Si bonds is small on an Si-containing layer surface or contact hole bottom surface. Specifically, where the number of Ti—Si bonds is small, their presence is less uniform, and a reaction of reactive TiClₓ with the active Si surface rapidly proceeds, whereby crystals are less uniformly formed, depending on the number of Ti—Si bonds on the contact hole bottom surface. At a contact hole portion where the number of Ti—Si bonds is relatively large, TiSi₂ crystals are formed to be relatively compact with a uniform grain size. On the other hand, at a contact hole portion where the number of Ti—Si bonds is relatively small, TiSi₂ crystals are formed to have a relatively low density with a large grain size. Further, it is known that the Ti—Si reaction mechanism is affected due to the influence of a TiSi₂ initial reaction, thereby varying TiSi₂ crystallinity (orientation). As described above, conventionally, the grain size and crystallinity (orientation) of TiSi₂ crystals vary over the target object surface, so the resistivity of a TiSi₂ film is increased, and the contact between the TiSi₂ film and underlayer becomes less uniform, resulting in an increase in contact resistance. Problems of this kind are also present in forming another metal silicide.

In light of these problems, according to the second aspect, when a metal silicide film is formed, a metal-containing source gas is first supplied without plasma generation for a predetermined time. The third aspect is arranged to apply the second aspect to titanium silicide film formation, in which a Ti-containing source gas is first supplied without plasma generation for a predetermined time to produce Ti—Si bonds. With this arrangement, metal-silicon bonds are uniformly produced on the Si-containing portion before a metal silicide starts crystal growth. In the case of titanium silicide, Ti—Si bonds are sufficiently produced on the Si-containing portion before TiSi₂ starts crystal growth. Consequently, when plasma is generated thereafter, metal-silicon bonds, such as Ti—Si bonds, make uniform crystal growth, so the crystal grains and crystallinity (orientation) can be uniform. It follows that the metal silicide (titanium silicide) has a low resistivity and makes uniform contact with the underlayer, thereby decreasing the contact resistance.

Also in the first aspect, in the process for forming a metal silicide film, it is preferable that a metal-containing source gas is first supplied without plasma generation for a predetermined time to produce metal-silicon bonds, and then plasma is generated. With this arrangement, it is possible to obtain the effect of forming a metal silicide film with a uniform crystal grain size, in addition to the affect of forming a metal silicide film with a smaller thickness and a lower resistivity than those obtained by the conventional technique without increasing the film formation temperature.

In the third aspect, the Ti-containing source gas may be first supplied without plasma generation for two seconds or more, and preferably five seconds or more. The Si-containing portion may comprise an Si-substrate, poly-Si, or metal silicide, and a typical example thereof is a contact diffusion layer formed in a mono-crystalline Si-substrate (Si wafer). This Si-substrate includes one doped with B, P, or As.

The natural oxide film may be removed by plasma using an RF, and the arrangement according to the third aspect is particularly effective in such a case. In this case, the natural oxide film removal by plasma using an RF is preferably performed, using inductively coupled plasma or remote plasma. The natural oxide film removal by plasma using an RF is preferably performed, while the target object is supplied with a self-bias voltage (Vdc) having an absolute value of 200V or more.

The titanium silicide film may be formed by keeping the Ti-containing source gas flowing while generating plasma. Further, the titanium silicide film may be formed by first supplying the Ti-containing source gas without plasma generation for a predetermined time to produce Ti—Si bonds, and then generating plasma while stopping the Ti-containing source gas and supplying a reducing gas to perform reduction of the Ti-containing source gas by plasma generation and supply of a reducing gas, and thereafter repeating, a plurality of times, supply of the Ti-containing source gas, and reduction of the metal-containing source gas by plasma generation and supply of the reducing gas.

According to a fourth aspect of the present invention, there is provided a film formation method for forming a metal silicide film on an Si-containing portion of a target object, the method comprising: a first step of supplying a metal-containing source gas, which contains a metal of the metal silicide film to be formed, onto the Si-containing portion of the target object without plasma generation for a predetermined time to produce metal-silicon bonds; and a second step of then supplying the metal-containing source gas and generating plasma to form a metal film containing the metal, thereby forming the metal silicide film by a reaction of the metal film with the Si-containing portion, wherein the second step comprises first supplying the metal-containing source gas at a lower flow rate, and then supplying the Ti-containing source gas at a higher flow rate.

According to a fifth aspect of the present invention, there is provided a film formation method for forming a titanium silicide film on an Si-containing portion of a target object, the method comprising: a first step of supplying a Ti-containing source gas onto the Si-containing portion of the target object without plasma generation for a predetermined time to produce Ti—Si bonds; and a second step of then supplying the Ti-containing source gas and generating plasma to form a Ti film, thereby forming the titanium silicide film by a reaction of the Ti film with the Si-containing portion, wherein the second step comprises first supplying the Ti-containing source gas at a lower flow rate, and then supplying the Ti-containing source gas at a higher flow rate.

In the process for forming a metal film while generating plasma, if a metal-containing source gas is supplied at a higher flow rate from the beginning, the interface morphology between the metal silicide and Si-containing portion may be deteriorated. For example, where the metal is Ti, if a Ti-containing source gas is supplied at a higher flow rate from the beginning, a reaction with Si rapidly proceeds. In this case, TiSi₂ crystals having a large grain size are formed, so the interface morphology between the TiSi₂ layer and Si-containing portion may be deteriorated. Further, TiSi₂ crystals having a large grain size may be also formed due to fluctuations of film formation parameters and plasma incident distribution (such as ion incident directions) on the Si-containing portion.

In light of these problems, according to the fourth aspect, a metal-containing source gas is supplied without plasma generation for a predetermined time to produce metal-silicon bonds, and, thereafter, plasma is generated while the metal-containing source gas is first supplied at a lower flow rate, and then supplied at a higher flow rate. The fifth aspect is arranged to apply the fourth aspect to titanium silicide film formation, in which a Ti-containing source gas is first supplied without plasma generation for a predetermined time to produce Ti—Si bonds, so that Ti—Si bonds are sufficiently present before TiSi₂ starts crystal growth. In addition, thereafter, plasma is generated to form a Ti film while the Ti-containing source gas is first supplied at a lower flow rate for a reaction with Si to gradually make progress. With this arrangement, metal silicide crystals having a small grain size are uniformly formed. In the case of titanium silicide, TiSi₂ crystals having a small grain size are uniformly formed. Consequently, when the gas is subsequently supplied at a higher flow rate to increase the film formation rate, crystal growth can be uniformly caused. It follows that a metal silicide (titanium silicide) film having fine and uniform crystal grains is formed, thereby improving the interface morphology.

Also in the third aspect, in the process for forming a Ti film while generating plasma, it is preferable that a Ti-containing source gas is first supplied at a lower flow rate, and then supplied at a higher flow rate. With this arrangement, it is possible to obtain the effect of forming a titanium silicide film with a smaller crystal grain size, thereby improving the interface morphology, in addition to the effect of forming a titanium silicide film with a uniform crystal grain size.

Also in the third and fifth aspects, in the process for forming a Ti film while generating plasma, it is preferable that a Ti-containing source gas is first supplied at a lower flow rate, and then supplied at a higher flow rate, wherein the lower flow rate is set to be within a range of 0.0005 to 0.012 L/min, and the higher flow rate is set to be within a range of 0.0046 to 0.020 L/min.

The Ti film may be formed by supplying TiCl₄ gas, H₂ gas, and Ar gas. It is preferable that the titanium silicide film is formed by setting a worktable for placing the target object thereon at a temperature within a range of 350 to 700° C.

In the second and fourth aspects, examples of the metal are Ni, Co, Pt, Mo, Ta, Hf, and Zr, in addition to Ti described above.

According to the present invention, in the process for performing a plasma process using an RF on an Si-containing portion prior to film formation, a target object is supplied with a DC bias voltage (Vdc) having an absolute value of 200V or more. With this arrangement, a metal silicide film with a smaller thickness and a lower resistivity than those obtained by the conventional technique can be formed without increasing the film formation temperature.

Where, a metal silicide film, such as titanium silicide film, is formed, a metal-containing source gas is supplied without plasma generation for a predetermined time to produce metal-silicon bonds, so the metal silicide film can be formed with uniform crystals.

Further, in addition to the arrangement that a metal-containing source gas is supplied without plasma generation for a predetermined time to produce metal-silicon bonds; the plasma is generated while the metal-containing source gas is first supplied at a lower flow rate to uniformly form metal silicide crystals with a small grain size, so the metal silicide film can be formed with an improved interface morphology.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIGS. 1A to 1D are sectional views for explaining steps of a film formation method according to a first embodiment of the present invention;

FIG. 2 is a sectional view schematically showing the structure of an apparatus for processing an Si wafer surface by plasma using an RF;

FIG. 3 is a sectional view schematically showing the structure of a Ti film formation apparatus;

FIGS. 4A to 4D are sectional views for explaining steps of a film formation method according to a second embodiment of the present invention;

FIG. 5 is a chart showing the timing of gas supply and plasma generation in a TiSi₂ film formation step according to the second embodiment of the present invention;

FIG. 6 is a chart showing the timing of gas supply and plasma generation in a TiSi₂ film formation step according to a third embodiment of the present invention;

FIG. 7A is a view schematically showing the cross section of TiSi₂ crystals, where a Ti film is formed by generating plasma and supplying a gas at a higher flow rate from the beginning, and FIG. 7B is a view schematically showing the cross section of TiSi₂ crystals formed by the third embodiment of the present invention;

FIG. 8 is a view showing an X-ray diffraction profile of a TiSi₂ film manufactured by the first embodiment of the present invention;

FIG. 9 is a view showing an image, obtained by a scanning electron microscope (SEM), of a cross section of a TiSi₂ film manufactured by the first embodiment of the present invention;

FIG. 10 is a view showing an X-ray diffraction profile of a TiSi₂ film manufactured by the second embodiment of the present invention;

FIG. 11 is a view showing an image, obtained by a scanning electron microscope (SEM), of a cross section of a TiSi₂ film manufactured by the second embodiment of the present invention;

FIG. 12 is a view comparing an X-ray diffraction profile of a TiSi₂ film manufactured by the first embodiment of the present invention, with an X-ray diffraction profile of a TiSi₂ film formed after a plasma process was performed with Vdc set at a normal value of −200V, and an X-ray diffraction profile of a TiSi₂ film formed without such a plasma process;

FIG. 13 is a view showing an image, obtained by a scanning electron microscope (SEM), of a cross section of a TiSi₂ film manufactured by a conventional method; and

FIG. 14 is a block diagram schematically showing the structure of a control section.

### DETAILED DESCRIPTION OF THE INVENTION

Embodiments of the present invention will be described hereinafter with reference to the accompanying drawings. These embodiments will be exemplified by a case where a Ti-containing source gas is used as a metal-containing source gas to form a titanium silicide film on an Si wafer.

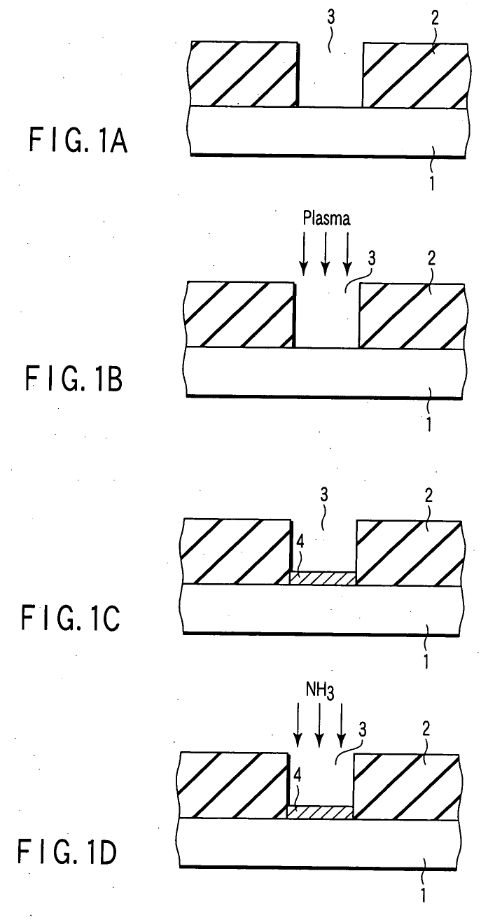

FIGS. 1A to 1D are views for explaining steps of a film formation method according to a first embodiment of the present invention.

In the first embodiment, at first, as shown in FIG. 1A, an interlayer insulating film 2 is formed on an Si wafer 1 and etched to form a contact hole 3 reaching the surface of the Si wafer 1. Then, as shown in FIG. 1B, while the Si wafer 1 is supplied with a DC bias voltage having an absolute value of 200V or more, the surface of the Si wafer 1 is processed by plasma using an RF. Then, as shown in FIG. 1C, a Ti-containing source gas, such as TiCl₄, is supplied to the Si wafer 1 and turned into plasma to form a Ti film, so that a TiSi₂ film 4 is formed by a reaction of the Ti film with Si of the Si wafer 1. In this case, the wafer 1 is preferably transferred from the plasma process to the Ti film formation through a vacuum. Thereafter, as needed, as shown in FIG. 1D, NH₃ is supplied to perform a nitridation process on the surface of the TiSi₂ film 4, as a pre-process prior to the subsequent TiN film formation.

Next, an explanation will be given of an apparatus for performing the plasma process shown in FIG. 1B and an apparatus for performing the TiSi₂ film formation process shown FIG. 1C, which are main processes in this embodiment.

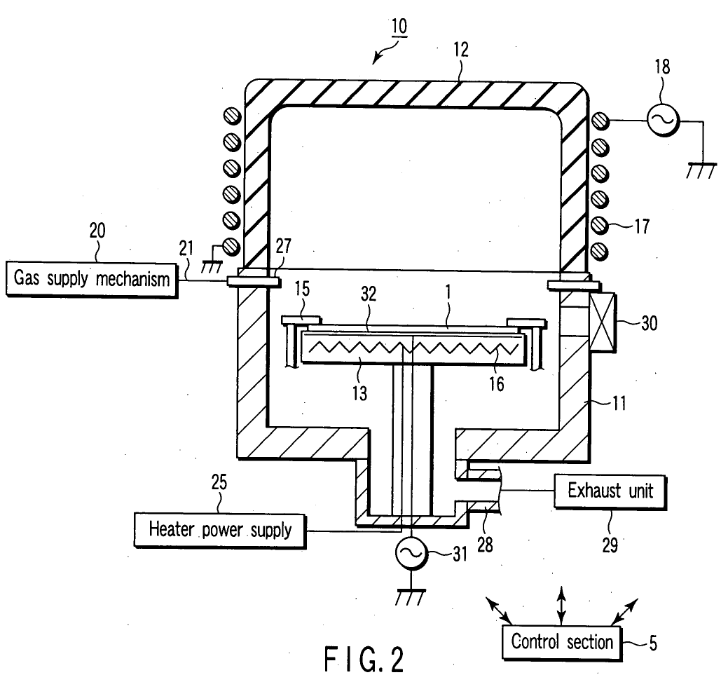

FIG. 2 is a sectional view schematically showing the structure of a plasma processing apparatus for performing the process shown in FIG. 1B. This apparatus is of the inductively coupled plasma (ICP) type, and basically configured to remove natural oxide films. In the first embodiment, however, this apparatus can perform not only removal of natural oxide films, but also a process using ions while applying an RF bias to the Si wafer 1 to attract ions to the surface of the Si wafer 1.

The plasma processing apparatus 10 for performing a plasma process using an RF includes an essentially cylindrical chamber 11, and an essentially cylindrical bell jar 12 disposed on top of and continuously to the chamber 11. The chamber 11 is provided with a susceptor 13 disposed therein to horizontally support a target object or Si wafer 1. The susceptor 13 is made of a ceramic, such as AlN, and supported by a cylindrical support member 14. The susceptor 13 is provided with a clamp ring 15 disposed at the peripheral portion for clamping the Si wafer 1. Further, the susceptor 13 has a heater 16 embedded therein for heating the Si wafer 1. The heater 16 is supplied with electricity from a heater power supply 25 to heat the target object or Si wafer 1 to a predetermined temperature.

The bell jar 12 is made of an electrically insulating material, such as quartz or a ceramic material, and is provided with a coil 17 wound therearound as an antenna member. The coil 17 is connected to an RF power supply 18. The RF power supply 18 has a frequency within a range of 300 kHz to 60 MHz, and preferably of 450 kHz. An RF power is applied from the RF power supply 18 to the coil 17 to form an induction electromagnetic field within the bell jar 12.

A gas supply mechanism 20 is arranged to supply gases for the plasma process into the chamber 11, and includes gas supply sources of predetermined gases, lines from the respective gas supply sources, switching valves, and mass-flow controllers for controlling flow rates (all of them are not shown). A gas feed portion, such as a gas feed nozzle 27, is inserted into the sidewall of the chamber 11, and is connected to a line 21 extending from the gas supply mechanism 20, so that a predetermined gas is supplied into the chamber 11 through the gas feed nozzle 27. The valves and mass-flow controllers on the lines are controlled by a controller (not shown).

Examples of the plasma process gas are Ar, Ne, and He, each of which can be solely used. Alternatively, the gas may be a mixture of H₂ with any one of Ar, Ne, and He, or a mixture of NF₃ with any one of Ar, Ne, and He. Of them, Ar alone or Ar and H₂ mixture is preferable.

The bottom wall of the chamber 11 is connected to an exhaust unit 29 including a vacuum pump through an exhaust line 28. The exhaust unit 29 is operated to decrease the pressure inside the chamber 11 and bell jar 12 to a predetermined vacuum level.

A gate valve 30 is disposed on the sidewall of the chamber 11, so that the wafer 1 can be transferred between the chamber 11 and an adjacent load lock chamber (not shown) when the gate valve 30 is opened.

The susceptor 13 further has an electrode 32 embedded therein and formed of, e.g., tungsten or molybdenum wires netted to a mesh. The electrode 32 is connected to an RF power supply 31 for applying a negative DC bias to the electrode 32.

When the plasma process is performed in the apparatus thus structured, the gate valve 30 is opened, and an Si wafer 1 is loaded into the chamber 11, placed on the susceptor 13, and clamped by the clamp ring 15. Then, the gate valve 30 is closed, and the interior of the chamber 11 and bell jar 12 is exhausted by the exhaust unit 29 to set a predetermined vacuum state. Then, a predetermined gas, such as Ar gas or Ar and H₂ gases, is supplied from the gas supply mechanism 20 through the gas feed nozzle 27 into the chamber 11. At the same time, an RF power is applied from the RF power supply 18 to the coil 17 to form an induction electromagnetic field within the bell jar 12, thereby generating plasma.

On the other hand, an RF power is applied from the power supply 31 to the susceptor 13, and a negative bias voltage or DC bias voltage (Vdc) is thereby applied to the Si wafer 1. With Vdc thus applied, ions in plasma are attracted to the Si wafer 1. In this embodiment, the powers of the RF power supplies 18 and 31 are adjusted to set Vdc to have an absolute value of 200V or more. For example, where the RF power supply 18 is at 500W and the RF power supply 31 is at 800W, it brings about Vdc=−530V.

For example, Vdc is within a range of about −100 to −180V for ordinary oxide film removal. This embodiment adopts an arrangement such that applied Vdc becomes higher than that for ordinary natural oxide film removal. Where such a high value of Vdc is used, ions in plasma act on the surface of the Si wafer 1 more intensively than in conventional natural oxide film removal. With this arrangement, the surface of the Si wafer 1, which is a film formation underlayer, is turned amorphous overall and becomes a highly reactive state. Consequently, as described later, when a TiSi₂ film is subsequently formed, it is possible to mainly form TiSi₂ of the C54 crystal structure, which can decrease the contact resistance. The absolute value of Vdc is set preferably at 250V or more and more preferably at 300V or more.

As regards the process conditions at this time, for example, the pressure is set to be within a range of 0.01 to 13.3 Pa, and preferably of 0.04 to 2.7 Pa, the wafer temperature is set to be within a range of room temperature to 500° C., the gas flow rate of each of Ar and H₂ is set to be within a range of 0.001 to 0.02 L/min, the RF power supply 18 for ICP is set to have a frequency of 450 kHz at a power level of 200 to 1,500W, and the RF power supply 31 for bias is set to have a frequency of 13.56 MHz at a power level of 100 to 1,000W.

Next, an explanation will be given of a Ti film formation apparatus for performing the TiSi₂ film formation process shown in FIG. 1C, which is subsequently performed.

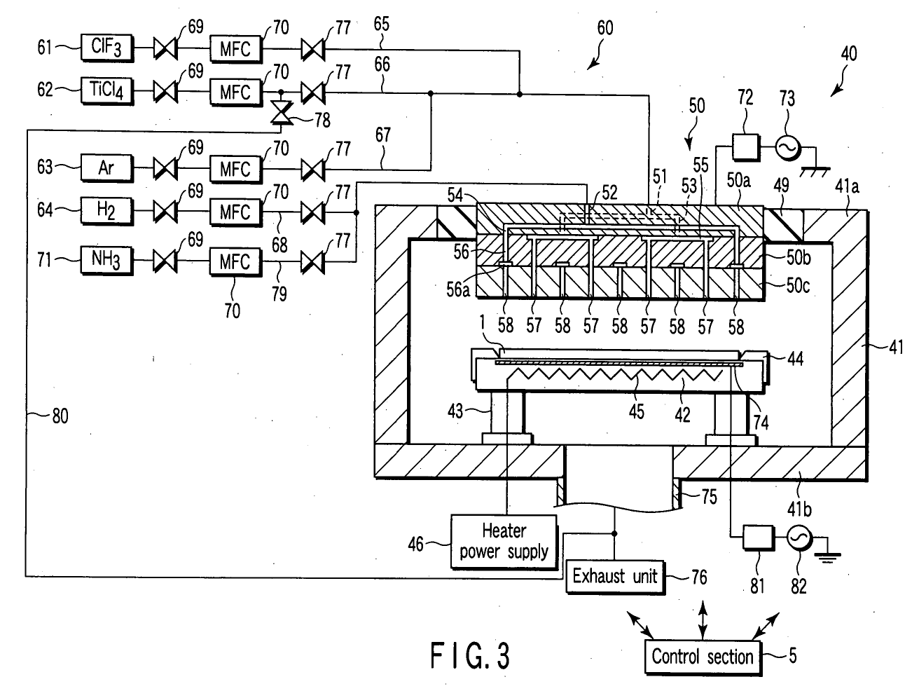

FIG. 3 is a sectional view schematically showing the structure of a Ti film formation apparatus. This film formation apparatus 40 includes an airtight and essentially cylindrical chamber 41, which is provided with a susceptor 42 disposed therein to horizontally support a target object or Si wafer 1. The susceptor 42 is made of a ceramic, such as AlN, and supported by a cylindrical support member 43.

The susceptor 42 is provided with a guide ring 44 at the peripheral portion for guiding the Si wafer 1. This guide ring 44 also serves a plasma focusing effect. Further, the susceptor 42 has a heater 45 of the resistance heating type embedded therein and made of molybdenum or tungsten wires. The heater 45 is supplied with electricity from a heater power supply 46 to heat the target object or Si wafer 1 to a predetermined temperature. The Si wafer 1 is transferred to and from the susceptor 42 through a state where the Si wafer 1 is lifted by three lifter pins, which can project and retreat to and from the susceptor 42.

A showerhead 50 is disposed on the top wall 41a of the chamber 41 by an insulating member 49. This showerhead 50 is formed of an upper block body 50a, a middle block body 50b, and a lower block body 50c. The lower block body 50c has delivery holes 57 and 58 alternately formed to deliver gases. A first gas feed port 51 and a second gas feed port 52 are formed in the top surface of the upper block body 50a. The upper block body 50a has a number of gas passages 53 formed therein and branched from the first gas feed port 51. The middle block body 50b has gas passages 55 formed therein and communicating with the gas passages 53. The gas passages 55 communicate with the delivery holes 57 of the lower block body 50c.

Further, the upper block body 50a has a number of gas passages 54 formed therein and branched from the second gas feed port 52. The middle block body 50b has gas passages 56 formed therein and communicating with the gas passages 54. The gas passages 56 communicate with gas passages 56a, which communicate with the delivery holes 58 of the lower block body 50c. The first and second gas feed ports 51 and 52 are connected to gas lines of a gas supply mechanism 60.

The gas supply mechanism 60 includes a ClF₃ gas supply source 61 for supplying ClF₃ gas as a cleaning gas, a TiCl₄ gas supply source 62 for supplying TiCl₄ gas as a Ti-containing gas, an Ar gas supply source 63 for supplying Ar gas as a plasma gas, a H₂ gas supply source 64 for supplying H₂ gas as a reducing gas, and an NH₃ gas supply source 71 for supplying NH₃ gas. The ClF₃ gas supply source 61 is connected to a gas line 65, the TiCl₄ gas supply source 62 is connected to a gas line 66, the Ar gas supply source 63 is connected to a gas line 67, the H₂ gas supply source 64 is connected to a gas line 68, and the NH₃ gas supply source 71 is connected to a gas line 79.

Each of the lines is provided with a valve 69, a valve 77, and a mass-flow controller 70. The gas line 66 extending from the TiCl₄ gas supply source 62 is connected through a valve 78 to a gas line 80 extending from an exhaust unit 76. The first gas feed port 51 is connected to a gas line 66 extending from the TiCl₄ gas supply source 62. The gas line 66 is connected to a gas line 65 extending from the ClF₃ gas supply source 61 and a gas line 67 extending from the Ar gas supply source 63. The second gas feed port 52 is connected to a gas line 68 extending from the H₂ gas supply source 64 and a gas line 79 extending from the NH₃ gas supply source 71.

Accordingly, during processing, TiCl₄ gas from the TiCl₄ gas supply source 62 is carried by Ar gas and supplied through the gas line 66 into the showerhead 50 via the first gas feed port 51 of the showerhead 50. Then, this gas flows through the gas passages 53 and 55 and is delivered from the delivery holes 57 into the chamber 41. On the other hand, H₂ gas from the H₂ gas supply source 64 is supplied through the gas line 68 into the showerhead 50 via the second gas feed port 52 of the showerhead 50. Then, this gas flows through the gas passages 54 and 56 and is delivered from the delivery holes 58 into the chamber 41. In other words, the showerhead 50 is of the post-mix type in which TiCl₄ gas and H₂ gas are supplied into the chamber 41 totally independently of each other, so that they are mixed and caused to react with each other after being delivered. The valves and mass-flow controllers on the gas lines are controlled by a controller (not shown).

The showerhead 50 is connected to an RF power supply 73 through a matching unit 72. An RF power is applied from the RF power supply 73 to the showerhead 50 to turn the gases into plasma, while the gases are being supplied through the showerhead 50 into the chamber 41, thereby performing a film formation reaction. On the other hand, the susceptor 42 has an electrode 74 embedded in the upper portion and formed of, e.g., molybdenum wires netted to a mesh. The electrode 74 serves as a counter electrode relative to the showerhead 50 that serves as an electrode supplied with an RF power. The electrode 74 is connected to an RF power supply 82 through a matching unit 81 to apply an RF voltage for providing a bias voltage to the electrode 74.

The bottom wall 41b of the chamber 41 is connected to an exhaust unit 76 including a vacuum pump through an exhaust line 75. The exhaust unit 76 is operated to decrease the pressure inside the chamber 41 to a predetermined vacuum level.

Next, a Ti film formation process performed in the Ti film formation apparatus will be explained.

At first, the interior of the chamber 41 is heated to a temperature within a range of 500 to 700° C. by the heater 45, and is exhausted by the exhaust unit 76 to set a predetermined vacuum state. Then, Ar and H₂ gases are supplied into the chamber 41 at a predetermined flow rate ratio such that, for example, Ar gas is within a range of 0.1 to 5 L/min, and H₂ gas is within a range of 0.5 to 10 L/min. At the same time, an RF power is applied from the RF power supply 73 to the showerhead 50 to generate plasma within the chamber 41. Further, TiCl₄ gas is supplied into the chamber 41 at a predetermined flow rate within a range of, e.g., 0.001 to 0.05 L/min to perform a pre-coating process of a Ti film. Thereafter, the supply of TiCl₄ gas is stopped, and NH₃ gas is supplied into the chamber 41 at a flow rate within a range of, e.g., 0.1 to 3 L/min to generate plasma, so as to nitride and thereby stabilize the pre-coating Ti film.

Then, a gate valve (not shown) is opened, and an Si wafer 1 is loaded from a load lock chamber (not shown) into the chamber 41 and placed on the susceptor 42. Then, the interior of the chamber 41 is exhausted by the exhaust apparatus 76, and the wafer 1 is heated by the heater 45. Further, into the chamber 41, H₂ gas is supplied at a flow rate within a range of 0.5 to 10.0 L/min, and preferably of 0.5 to 5.0 L/min, and Ar gas is supplied at a flow rate within a range of 0.1 to 5.0 L/min, and preferably of 0.3 to 2.0 L/min. Then, while the supply of Ar gas and H₂ gas is maintained, the interior of the chamber 41 is set at a pressure within a range of 40 to 1,333 Pa, and preferably of 133.3 to 666.5 Pa. Then, while these flow rates are maintained, TiCl₄ gas is supplied into the chamber 41 at a flow rate within a range of 0.001 to 0.05 L/min, and preferably of 0.001 to 0.02 L/min to perform pre-flow. Then, while the Si wafer 1 is heated by the heater 45 at a temperature (susceptor temperature) within a range of about 500 to 700° C., and preferably at about 600° C., an RF power is applied from the RF power supply 73 to the showerhead 50, with a frequency within a range of 300 kHz to 60 MHz, and preferably of 400 kHz to 13.56 MHz, such as 450 kHz, and at a power level within a range of 200 to 1,000W, and preferably of 200 to 500W, to generate plasma within the chamber 41, thereby forming a Ti film within the gas plasma.

When the Ti film is deposited, as described above, the Ti film takes in Si from the underlying Si wafer 1, so a TiSi₂ film is formed by a reaction between Ti and Si. In this case, as described above, the surface of the Si wafer 1 is supplied with Vdc having an absolute value of 200V, which is far higher than those used in the conventional natural oxide film removal. Thus, not only natural oxide films are removed on the surface of the Si wafer 1, but also ions in plasma intensively act on the surface of the Si wafer 1. Due to the presence of such ions, the underlying surface of the Si wafer 1 for the film formation is made amorphous overall, wherein Si dangling bonds (disconnected bonds) are present more than in mono-crystalline Si, i.e., a highly reactive state is formed. Consequently, a large amount of titanium silicide of the C54 crystal structure, which provides a lower resistivity, can be formed at a wafer temperature lower than the conventional value. It follows that a titanium silicide film with a smaller thickness and a lower resistivity than those obtained by the conventional technique can be formed without increasing the film formation temperature, thereby lowering the contact resistance.

Since the underlying surface of the Si wafer 1 is in such a highly reactive state, the temperature necessary for forming a TiSi₂ film equivalent to the conventional TiSi₂ film can be decreased by about 50 to 100° C.

In the case described above, the Ti film is formed by simultaneously performing TiCl₄ gas supply, H₂ gas supply, and plasma generation. Alternatively, it may be adopted such that TiCl₄ gas is first supplied for a short time to cause a Ti film adsorption reaction (i.e., a reaction between Ti and Si), and then a step of supplying TiCl₄ gas, H₂ gas, and Ar gas while generating plasma to form a Ti film, and a step of supplying H₂ gas and Ar gas while generating plasma are repeated a plurality of times, e.g., an ALD (Atomic Layered Deposition) process is performed. In this case, the film formation temperature can be further decreased to 500° C. or less, such as about 350° C. Alternatively, in the Ti film formation, it may be adopted such that a TiCl₄ gas is supplied for a predetermined time prior to plasma generation to produce Ti—Si bonds on an Si wafer, and then plasma is generated. In this case, the resistivity of a titanium silicide film is further decreased. In this case, the wafer 1 is preferably transferred from the natural oxide film removal to the Ti film formation through a vacuum (as in a cluster tool).

Thereafter, a process for nitriding the surface of the TiSi₂ film 4 is carried out, as needed. At this time, in the apparatus shown in FIG. 3, the susceptor 42 is set at a temperature within a range of about 350 to 700° C. and preferably at 600° C. Further, NH₃ gas is supplied into the chamber 41 from the NH₃ gas supply source 71 at a flow rate of, e.g., 0.1 to 3 L/min, together with Ar gas and H₂ gas, and an RF is applied to generate plasma, thereby performing the process. During the nitridation process, the pressure and temperature inside the chamber 41, plasma generation conditions, Ar gas flow rate, and H₂ gas flow rate are the same as those of the Ti film formation.

Then, the TiSi film formed as described above is nitrided, and a TiN film is formed thereon by CVD, on which an interconnection layer of, e.g., Al, W, or Cu is further formed. These processes may be performed in the chamber used for forming the Ti film or in other chambers.

After the film formation is performed on a predetermined number of wafers, ClF₃ gas is supplied into the chamber 41 from the ClF₃ gas supply source 61 to perform cleaning of the interior of the chamber.

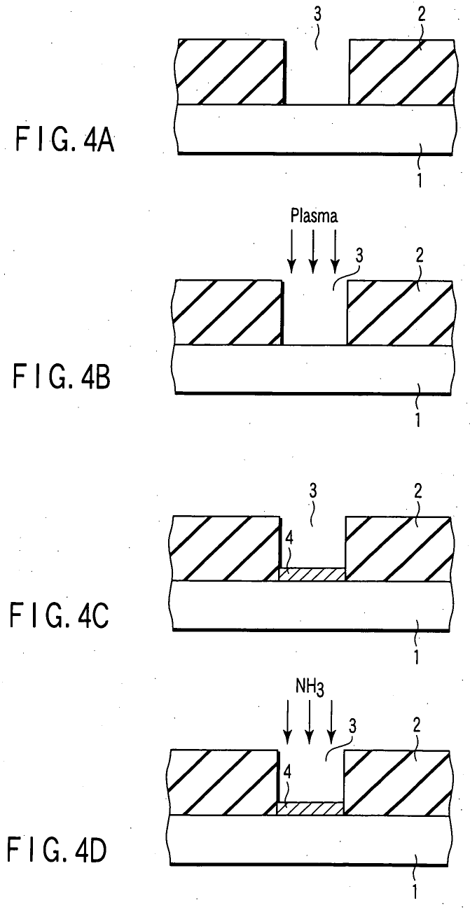

Next, an explanation will be given of a second embodiment of the present invention. FIGS. 4A to 4D are sectional views for explaining steps of a film formation method according to the second embodiment of the present invention.

In the second embodiment, as shown in FIG. 4A, the same process as in FIG. 1A is first performed, and then, as shown in FIG. 4B, natural oxide films on the surface of the Si wafer 1 are removed by plasma using an RF. Then, as shown in FIG. 4C, a Ti-containing source gas, such as TiCl₄ gas, is supplied to the Si wafer 1, and turned into plasma to form a Ti film, so that a TiSi₂ film 4 is formed by a reaction of the Ti film with Si of the Si wafer 1. Although this process is basically the same as that shown in FIG. 1C, this embodiment has differences as follows. Specifically, H₂ gas and Ar gas are first supplied, then a Ti-containing source gas, such as TiCl₄ gas, is supplied without plasma generation for predetermined time to produce Ti—Si bonds, and then plasma is generated. Thereafter, as needed, the same process as in FIG. 4D is performed as a plasma nitridation process on the surface of the TiSi₂ film 4.

In this embodiment, the process shown in FIG. 4B for removing natural oxide films may be performed in an apparatus of the same type as the apparatus for performing the step shown in FIG. 1B of the first embodiment. Since this embodiment needs only to remove natural oxide films, this process may be performed while Vdc of the Si wafer is set to have an absolute value of about 100 to 180V, and the other conditions are set to be the same as those of the conditions described above. However, also in this embodiment, it is effective to set Vdc to have an absolute value of 200V or more.

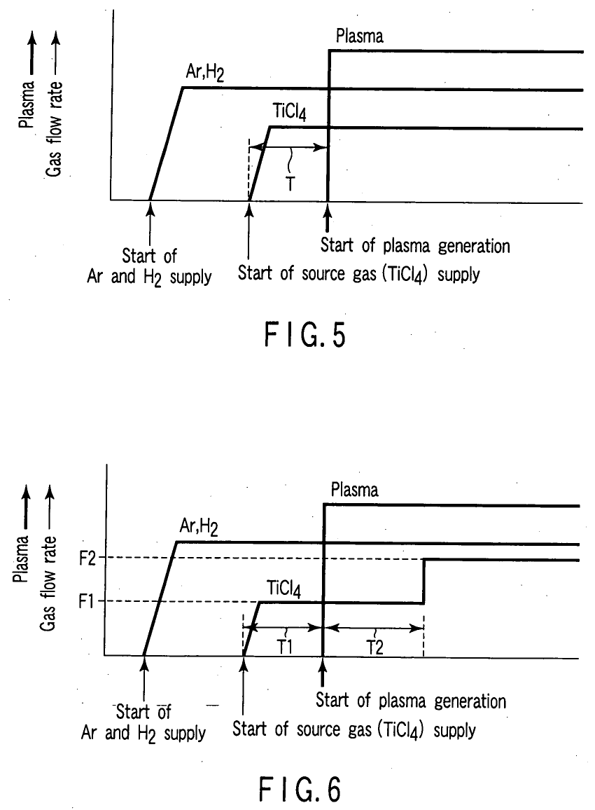

The subsequent process for forming a TiSi₂ film shown in FIG. 4C is performed by the apparatus shown in FIG. 3, under basically the same film formation conditions. However, in this embodiment, the process is performed such that TiCl₄ is supplied without generating plasma, and then plasma is generated. Specifically, an Si wafer 1 is placed on the susceptor 42, and heated by the heater 45. Further, the interior of the chamber 41 is exhausted by the exhaust unit 76 to set the interior of the chamber 41 to the predetermined pressure described above. In this state, as described in the timing chart shown in FIG. 5, H₂ gas and Ar gas are supplied into the chamber 41 at the predetermined flow rates described above to perform pre-flow. Then, while these flow rates are maintained, TiCl₄ gas is supplied at the predetermined flow rate described above for T seconds to produce Ti—Si bonds on the Si wafer 1. Thereafter, an RF power is applied from the RF power supply 73 at the predetermined level described above to generate plasma in the chamber 41 to continue the film formation process. The supply of TiCl₄ gas prior to plasma generation is performed for a time T of two seconds or more, and preferably of 2 to 30 seconds, such as 10 seconds.

In this respect, conventionally, supply of TiCl₄ gas used as a Ti-containing source gas and plasma generation are simultaneously performed, so plasma is generated before a sufficient amount of TiCl₄ gas is supplied onto the surface of an Si wafer 1. In this case, TiSi₂ starts rapid crystal growth in a state where the number of Ti—Si bonds is small on the surface of the Si wafer 1 or contact hole bottom surface. Consequently, crystals abnormally grow depending on the number of Ti—Si bonds on the contact hole bottom surface, thereby forming a less uniform state. For example, on an Si contact surface having a diameter of 0.2 μm, several TiSi₂ crystal grains are formed in a case where they have a relatively large size of about 50 nm, or 10 to 20 TiSi₂ crystal grains are formed in a case where they have a relatively small size of about 20 nm. Conventionally, the contact resistance is increased due to this phenomenon. On the other hand, according to this embodiment, TiCl₄ gas used as a Ti-containing source gas is first supplied without plasma generation for a predetermined time to gradually produce Ti—Si bonds allover the surface of the Si wafer 1. With this arrangement, Ti—Si bonds are sufficiently produced before TiSi₂ starts crystal growth. Consequently, when plasma is generated after the predetermined time, TiSi₂ makes uniform crystal growth, so the crystal grains and crystallinity (orientation) can be uniform. It follows that titanium silicide has a low resistivity and makes uniform contact with the Si wafer 1, thereby decreasing the contact resistance.

Also in this embodiment, TiCl₄ gas supply, and H₂ gas or reducing gas supply with plasma generation may be alternately performed in the Ti film formation, as in the first embodiment. In this case, first TiCl₄ supply corresponds to pre-flow.

Then, the TiSi film formed as described above is nitrided, and a TiN film is formed thereon by CVD, on which an interconnection layer of, e.g., Al, W, or Cu is further formed.

Next, an explanation will be given of a third embodiment of the present invention.

In the third embodiment, the same processes as in FIGS. 4A and 4B are performed to form a contact hole on an Si wafer 1, and then remove oxide films on the Si wafer surface by plasma using an RF. Then, the same process as in the FIG. 4C is performed to form a TiSi₂ film. Although this step of forming a TiSi₂ film is basically the same as that shown in FIG. 4C, this embodiment has differences as follows. Specifically, TiCl₄ gas used as a Ti-containing source gas is first supplied without plasma generation for a predetermined time to produce Ti—Si bonds. Then, plasma is generated to form a Ti film, while TiCl₄ gas used as a Ti-containing source gas is first supplied at a lower flow rate and then supplied at a higher flow rate. Thereafter, as needed, the same process as in FIG. 4D is performed as a nitridation process on the surface of the TiSi₂ film.

According to this embodiment, in the step of forming a TiSi₂ film, as described in the timing chart shown in FIG. 6, H₂ gas and Ar gas are supplied into the chamber 41 at predetermined flow rates to perform pre-flow. Then, while these flow rates are maintained, TiCl₄ gas is supplied at a predetermined flow rate (lower flow rate F1) for T seconds to produce Ti—Si bonds on the Si wafer 1. Then, while TiCl₄ gas is supplied at the lower flow rate F1, an RF power is applied from the RF power supply 73 at the predetermined level described above to generate plasma in the chamber 41 to start a film formation process. This TiCl₄ gas supply at the lower flow rate F1 is kept for T2 seconds for a reaction with Si to gradually make progress. Then, the flow rate of TiCl₄ gas is increased to a higher flow rate F2 to perform the film formation at a higher film formation rate.

The TiCl₄ gas flow rate can be suitably set to be within a range of 0.0005 to 0.02 L/min in accordance with the volume of the chamber. In the case of chambers used in Ti film formation apparatuses for 300 mmφ-wafers, for example, the lower flow rate F1 is set to be within a range of 0.001 to 0.012 L/min, and the higher flow rate F2 is set to be within a range of 0.012 to 0.020 L/min. In the case of chambers for 200 mmφ-wafers, for example, the lower flow rate F1 is set to be within a range of 0.0005 to 0.0046 L/min, and the higher flow rate F2 is set to be within a range of 0.0046 to 0.010 L/min. The supply time T1 of TiCl₄ prior to plasma generation is set to be within a range of, e.g., 1 to 30 seconds. The supply time T2 of TiCl₄ at the lower flow rate F1 is set to be within a range of, e.g., 5 to 60 seconds, and preferably of 5 to 30 seconds.

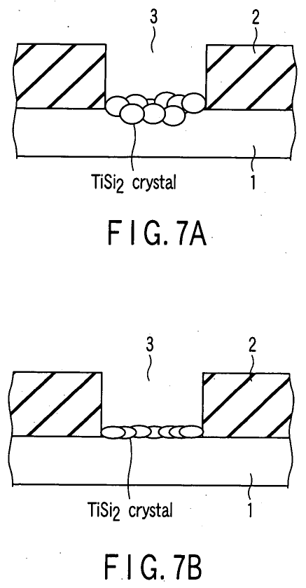

In the process for forming a Ti film while generating plasma, if a Ti-containing source gas is supplied at a higher flow rate for film formation from the beginning, a reaction with Si rapidly proceeds. In this case, as shown in FIG. 7A, TiSi₂ crystals having a large grain size are formed, so the morphology of the interface between the TiSi₂ film and Si wafer 1 may be deteriorated. In this respect, according to this embodiment, the gas is first supplied at a lower flow rate for a reaction with Si to gradually make progress, so that, as shown in FIG. 7B, TiSi₂ crystals having a small grain size are uniformly formed. Consequently, when the gas is subsequently supplied at a higher flow rate to increase the film formation rate, crystal growth can be uniformly performed. It follows that a titanium silicide film having fine and uniform crystal grains is formed, thereby improving the interface morphology.

As in the first embodiment, where the TiSi₂ film formation process is performed while the Si wafer is supplied with Vdc having an absolute value of 200V or more, TiSi₂ crystals having a large grain size tend to be formed, and thus the interface morphology tends to be deteriorated. In order to solve such problems, the method according to this embodiment may be effectively applied, in which TiCl₄ is supplied for a predetermined time prior to plasma generation, and, thereafter, TiCl₄ is first supplied at a lower flow rate while generating plasma to form a Ti film, thereby improving the interface morphology.

Next, an explanation will be given of experimental results performed to confirm effects of the present invention.

### (1) Experiment for First Embodiment

In this experiment, a plasma process using an RF was first performed on an Si wafer surface in the apparatus shown in FIG. 2. As regards the conditions of the process, the RF power supply 18 was set at a power level of 500W, the RF power supply 31 for bias was set at a power level of 800W to form Vdc at −530V. Thereafter, using the apparatus shown in FIG. 3, a process was performed for 31 seconds to form a TiSi₂ film having a thickness of 43 nm, while the susceptor temperature was set at 640° C., and the wafer temperature was set at 620° C.

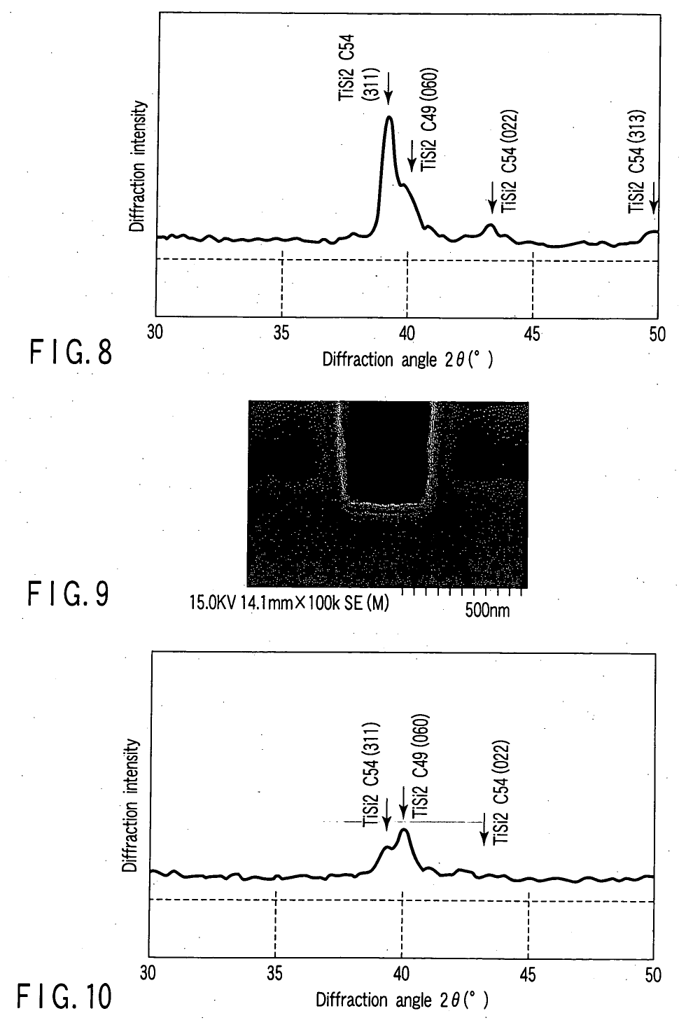

FIG. 8 shows an X-ray diffraction profile obtained in this experiment. As shown in FIG. 8, the TiSi₂ film formed in accordance with the first embodiment rendered a high peak intensity of TiSi₂ of the C54 crystal structure, wherein C54 formation of about 70% was confirmed.

FIG. 9 shows an SEM image of a cross section of this sample at a hole portion. The image of FIG. 9 shows a state after etching was performed with hydrofluoric acid to remove the TiSi₂ film by the etching. As shown in FIG. 9, the portion where the TiSi₂ film was present was thin and uniform, so it is estimated that the crystal grain size was uniform.

### (2) Experiment for Second Embodiment

In this experiment, natural oxide films were removed in the apparatus shown in FIG. 2. Thereafter, a TiSi₂ film is formed in the apparatus shown in FIG. 3, while TiCl₄ was supplied for 10 seconds prior to plasma generation. A process was performed for 20 seconds to form a TiSi₂ film having a thickness of 27 nm, while the susceptor temperature was set at 640° C., and the wafer temperature was set at 620° C.

FIG. 10 shows an X-ray diffraction profile obtained in this experiment. As shown in FIG. 10, a peak of TiSi₂ of the C54 crystal structure was observed, and thus C54 formation was confirmed.

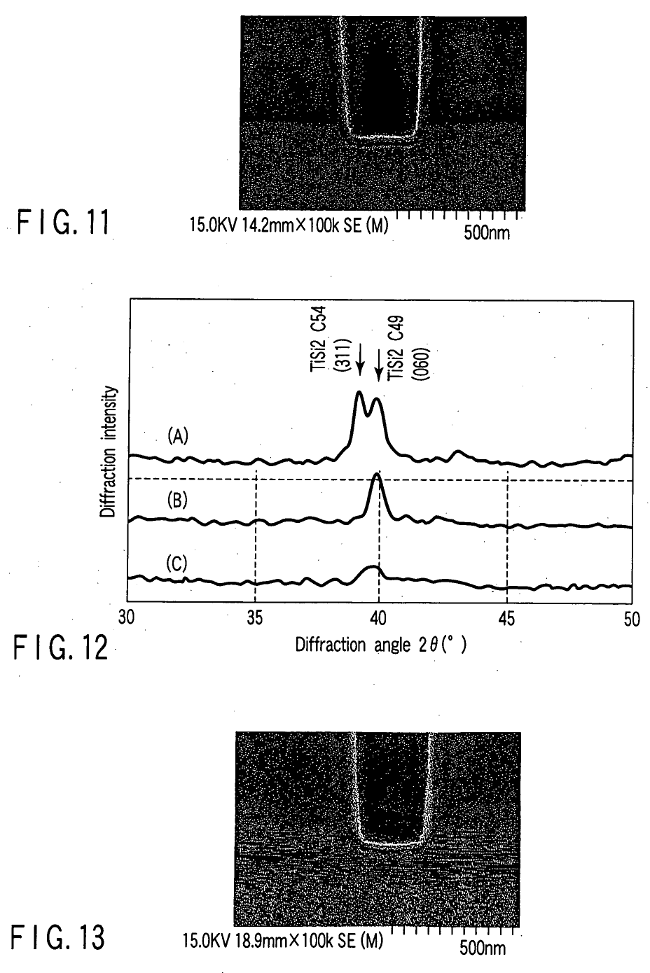

FIG. 11 shows an SEM image of a cross section of this sample at a hole portion. The image of FIG. 11 shows a state after etching was performed with hydrofluoric acid to remove the TiSi₂ film by the etching. As shown in FIG. 11, the portion where the TiSi₂ film was present was thin and uniform, so it is estimated that the crystal grain size was uniform.

### (3) Conventional Sample

FIG. 12 is a view comparing an X-ray diffraction profile (A) of another portion of the sample formed by the first embodiment, with an X-ray diffraction profile (B) of a sample film formed after a plasma process was performed with Vdc set at a condition used in ordinary natural oxide film removal, and an X-ray diffraction profile (C) of a sample film formed without such a plasma process. As shown in FIG. 12, it was confirmed that the sample (A) rendered a high C54 peak. Further, the sample (B), using an ordinary condition plasma process, rendered almost no peak of TiSi₂ of the C54 crystal structure, but mainly a peak of the C49 crystal structure. The sample (C), using no plasma process, rendered an even lower C49 peak as well, and thus had low crystallinity.

FIG. 13 is a view showing an SEM image of a cross section of the conventional sample at a hole portion, i.e., this sample did not utilize the present invention process. The image of FIG. 13 shows a state after etching was performed with hydrofluoric acid to remove the TiSi₂ film by the etching. As shown in FIG. 13, the portion where the TiSi₂ film was present was thick and less uniform, so it is estimated that the crystal grain size was less uniform.

The present invention is not limited to the embodiments, and it may be modified in various manners within the spirit or scope of the present invention. For example, in the embodiments, ICP plasma is utilized to perform a plasma process using an RF prior to TiSi₂ film formation, but this is not limiting. Another example is parallel plate type plasma (capacitive coupling plasma) or microwave plasma that directly supplies microwaves into a chamber. ICP plasma is preferable, because it is less likely that a target object will suffer unnecessary damage by this system. In the case of natural oxide film removal, as in the second embodiment, remote plasma is preferably used, because a substrate is less damaged by this system.

As an underlayer below a TiSi₂ film, an Si wafer is described as an example, but this is not limiting. The underlayer may be poly-Si or a metal silicide other than Ti, such as NiSi, CoSi, or MoSi. As a source gas, TiCl₄ gas is used as an example, but this is not limiting. The source gas may be any Ti-containing source gas, such as an organic titanium, e.g., TDMAT (dimethylaminotitanium) or TDEAT (diethylaminotitanium). Formation of a titanium silicide film using a Ti-containing source gas is described as an example, but this is not limiting. Alternatively, where a metal-containing source gas of a metal, such as Ni, Co, Pt, Mo, Ta, Hf, or Zr, is used to form a silicide film of this metal, effects of the same kind can be obtained.

In the third embodiment, after natural oxide film removal, a Ti-containing source gas is supplied without plasma generation for a predetermined time. Thereafter, Ti-containing source gas is first supplied at a lower flow rate, and then supplied at a higher flow rate while generating plasma to form a TiSi₂ film. This method of forming a TiSi₂ film may be applied to a case where natural oxide film removal is not performed. In this case, the effect of decreasing the crystal grain size of the TiSi₂ film is still effective, and thus the interface morphology can be improved.

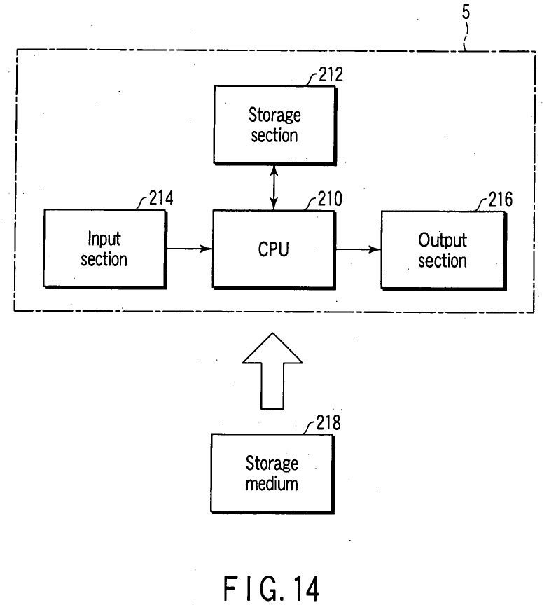

Each of the methods according to the embodiments described with reference to FIGS. 1 to 13 is performed under the control of a control section 5 (see FIGS. 2 and 3) in accordance with a process program, in a processing system including the apparatuses shown in FIGS. 2 and 3. FIG. 14 is a block diagram schematically showing the structure of the control section 5. The control section 5 includes a CPU 210, which is connected to a storage section 212, an input section 214, and an output section 216. The storage section 212 stores process programs and process recipes. The input section 214 includes input devices, such as a keyboard, a pointing device, and a storage media drive, to interact with an operator. The output section 216 outputs control signals for controlling components of the processing apparatus. FIG. 14 also shows a storage medium 218 attached to the computer in a removable state.

Each of the methods according to the embodiments described above may be written as program instructions for execution on a processor, into a computer readable storage medium or media to be applied to a semiconductor processing apparatus. Alternately, program instructions of this kind may be transmitted by a communication medium or media and thereby applied to a semiconductor processing apparatus. Examples of the storage medium or media are a magnetic disk (flexible disk, hard disk (a representative of which is a hard disk included in the storage section 212), etc.), an optical disk (CD, DVD, etc.), a magneto-optical disk (MO, etc.), and a semiconductor memory. A computer for controlling the operation of the semiconductor processing apparatus reads program instructions stored in the storage medium or media, and executes them on a processor, thereby performing a corresponding method, as described above.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A film formation method for forming a metal silicide film on an Si-containing portion of a target object, the method comprising:
performing a plasma process using an RF on the Si-containing portion; and
supplying a metal-containing source gas, which contains a metal of the metal silicide film to be formed, onto the Si-containing portion processed by the plasma process and generating plasma to form a metal film containing the metal, thereby forming the metal silicide film by a reaction of the metal film with Si of the Si-containing portion,
wherein the plasma process is performed on the Si-containing portion while the target object is supplied with a DC bias voltage (Vdc) having an absolute value of 200V or more.

2. The method according to claim 1, wherein the Si-containing portion comprises an Si-substrate, poly-Si, or metal silicide.

3. The method according to claim 1, wherein the plasma process is performed on the Si-containing portion, using inductively coupled plasma.

4. The method according to claim 1, wherein the plasma process is performed on the Si-containing portion, using parallel plate type plasma or microwave plasma.

5. The method according to claim 1, wherein the metal silicide film is formed by repeating, a plurality of times, supply of the metal-containing source gas, and reduction of the metal-containing source gas by plasma generation and supply of a reducing gas.

6. The method according to claim 1, wherein the metal silicide film is formed by first supplying the metal-containing source gas without plasma generation for a predetermined time to produce metal-silicon bonds, and then generating plasma.

7. The method according to claim 1, wherein the metal is selected from the group consisting of Ti, Ni, Co, Pt, Mo, Ta, Hf and Zr.

8. A film formation method for forming a metal silicide film on an Si-containing portion of a target object, the method comprising:
removing a natural oxide film on the Si-containing portion; and
forming the metal silicide film on the Si-containing portion of the target object after the natural oxide film is removed,
wherein the metal silicide film is formed by first supplying a metal-containing source gas, which contains a metal of the metal silicide film to be formed, without plasma generation for a predetermined time to produce metal-silicon bonds, and then supplying the metal-containing source gas and generating plasma to form a metal film containing the metal, thereby forming the metal silicide film by a reaction of the metal film with the Si-containing portion.

9. A film formation method for forming a titanium silicide film on an Si-containing portion of a target object, the method comprising:
removing a natural oxide film on the Si-containing portion; and
forming the titanium silicide film on the Si-containing portion of the target object after the natural oxide film is removed,
wherein the titanium silicide film is formed by first supplying a Ti-containing source gas without plasma generation for a predetermined time to produce Ti—Si bonds, and then supplying the Ti-containing source gas and generating plasma to form a Ti film, thereby forming the titanium silicide film by a reaction of the Ti film with the Si-containing portion.

10. The method according to claim 9, wherein the titanium silicide film is formed by first supplying the Ti-containing source gas without plasma generation for two seconds or more.

11. The method according to claim 9, wherein the Si-containing portion comprises an Si-substrate, poly-Si, or metal silicide.

12. The method according to claim 9, wherein the titanium silicide film is formed by keeping the Ti-containing source gas flowing while generating plasma.

13. The method according to claim 9, wherein the titanium silicide film is formed by first supplying the Ti-containing source gas without plasma generation for a predetermined time to produce Ti—Si bonds, and then generating plasma while stopping the Ti-containing source gas and supplying a reducing gas to perform reduction of the Ti-containing source gas by plasma generation and supply of a reducing gas, and thereafter repeating, a plurality of times, supply of the Ti-containing source gas, and reduction of the metal-containing source gas by plasma generation and supply of the reducing gas.

14. The method according to claim 9, wherein the titanium silicide film is formed by generating plasma to form the Ti film while first supplying the Ti-containing source gas at a lower flow rate, and/then supplying the Ti-containing source gas at a higher flow rate.

15. The method according to claim 14, wherein the lower flow rate is set to be within a range of 0.0005 to 0.012 L/min, and the higher flow rate is set to be within a range of 0.0046 to 0.020 L/min.

16. The method according to claim 9, wherein the natural oxide film is removed by plasma using an RF.

17. The method according to claim 16, wherein the natural oxide film is removed, using inductively coupled plasma.

18. The method according to claim 16, wherein the natural oxide film is removed, using remote plasma.

19. The method according to any one of claim 16, wherein the natural oxide film is removed while the target object is supplied with a DC bias voltage (Vdc) having an absolute value of 200V or more.

20. A film formation method for forming a metal silicide film on an Si-containing portion of a target object, the method comprising:
a first step of supplying a metal-containing source gas, which contains a metal of the metal silicide film to be formed, onto the Si-containing portion of the target object without plasma generation for a predetermined time to produce metal-silicon bonds; and
a second step of then supplying the metal-containing source gas and generating plasma to form a metal film containing the metal, thereby forming the metal silicide film by a reaction of the metal film with the Si-containing portion,
wherein the second step comprises first supplying the metal-containing source gas at a lower flow rate, and then supplying the Ti-containing source gas at a higher flow rate.

21. A film formation method for forming a titanium silicide film on an Si-containing portion of a target object, the method comprising:
a first step of supplying a Ti-containing source gas onto the Si-containing portion of the target object without plasma generation for a predetermined time to produce Ti—Si bonds; and
a second step of then supplying the Ti-containing source gas and generating plasma to form a Ti film, thereby forming the titanium silicide film by a reaction of the Ti film with the Si-containing portion, wherein the second step comprises first supplying the Ti-containing source gas at a lower flow rate, and then supplying the Ti-containing source gas at a higher flow rate.

22. The method according to claim 21, wherein the lower flow rate is set to be within a range of 0.0005 to 0.012 L/min, and the higher flow rate is set to be within a range of 0.0046 to 0.020 L/min.

23. The method according to claim 9, wherein the Ti film is formed by supplying TiCl₄ gas, H₂ gas, and Ar gas.

24. The method according to claim 9, wherein the titanium silicide film is formed by setting a worktable for placing the target object thereon at a temperature within a range of 350 to 700° C.

25. The method according to claim 8, wherein the metal is selected from the group consisting of Ti, Ni, Co, Pt, Mo, Ta, Hf and Zr.

26. The method according to claim 20, wherein the Ti film is formed by supplying TiCl₄ gas, H₂ gas, and Ar gas.

27. The method according to claim 21, wherein the Ti film is formed by supplying TiCl₄ gas, H₂ gas, and Ar gas.

28. The method according to claim 21, wherein the titanium silicide film is formed by setting a worktable for placing the target object thereon at a temperature within a range of 350 to 700° C.

29. The method according to claim 20, wherein the metal is selected from the group consisting of Ti, Ni, Co, Pt, Mo, Ta, Hf and Zr.

30. A computer readable medium containing program, instructions for execution on a processor, which, when executed by the processor, cause a processing system, for forming a metal silicide film on an Si-containing portion of a target object, to execute
performing a plasma process using an RF on the Si-containing portion; and
supplying a metal-containing source gas, which contains a metal of the metal silicide film to be formed, onto the Si-containing portion processed by the plasma process and generating plasma to form a metal film containing the metal, thereby forming the metal silicide film by a reaction of the metal film with Si of the Si-containing portion,
wherein the plasma process is performed on the Si-containing portion while the target object is supplied with a DC bias voltage (Vdc) having an absolute value of 200V or more.

31. A computer readable medium containing program instructions for execution on a processor, which, when executed by the processor, cause a processing system, for forming a metal silicide film on an Si-containing portion of a target object, to execute
removing a natural oxide film on the Si-containing portion; and
forming the metal silicide film on the Si-containing portion of the target object after the natural oxide film is removed,
wherein the metal silicide film is formed by first supplying a metal-containing source gas, which contains a metal of the metal silicide film to be formed, without plasma generation for a predetermined time to produce metal-silicon bonds, and then supplying the metal-containing source gas and generating plasma to form a metal film containing the metal, thereby forming the metal silicide film by a reaction of the metal film with the Si-containing portion.

32. A computer readable medium containing program instructions for execution on a processor, which, when executed by the processor, cause a processing system, for forming a titanium silicide film on an Si-containing portion of a target object, to execute
removing a natural oxide film on the Si-containing portion; and
forming the titanium silicide film on the Si-containing portion of the target object after the natural oxide film is removed,
wherein the titanium silicide film is formed by first supplying a Ti-containing source gas without plasma generation for a predetermined time to produce Ti—Si bonds, and then supplying the Ti-containing source gas and generating plasma to form a Ti film, thereby forming the titanium silicide film by a reaction of the Ti film with the Si-containing portion.

33. A computer readable medium containing program instructions for execution on a processor, which, when executed by the processor, cause a processing system, for forming a metal silicide film on an Si-containing portion of a target object, to execute
a first step of supplying a metal-containing source gas, which contains a metal of the metal silicide film to be formed, onto the Si-containing portion of the target object without plasma generation for a predetermined time to produce metal-silicon bonds; and
a second step of then supplying the metal-containing source gas and generating plasma to form a metal film containing the metal, thereby forming the metal silicide film by a reaction of the metal film with the Si-containing portion,
wherein the second step comprises first supplying the metal-containing source gas at a lower flow rate, and then supplying the Ti-containing source gas at a higher flow rate.

34. A computer readable medium containing program instructions for execution on a processor, which, when executed by the processor, cause a processing system, for forming a titanium silicide film on an Si-containing portion of a target object, to execute
a first step of supplying a Ti-containing source gas onto the Si-containing portion of the target object without plasma generation for a predetermined time to produce Ti—Si bonds; and
a second step of then supplying the Ti-containing source gas and generating plasma to form a Ti film, thereby forming the titanium silicide film by a reaction of the Ti film with the Si-containing portion,
wherein the second step comprises first supplying the Ti-containing source gas at a lower flow rate, and then supplying the Ti-containing source gas at a higher flow rate.
